(19) United States
(12) Patent Application Publication
(10) Pub. No.: US 2019/0213802 A1
(43) Pub. Date: Jul. 11, 2019

(54) METHODS AND SYSTEMS FOR AUTOMATED CELLULAR PARKING WITH OCCUPANCY CONTROL

(71) Applicant: Mobilisis, Verazdin - Jalkovec (HR)

(72) Inventor: Zvi Ganot, Beer Sheva (IL)

(21) Appl. No.: 16/299,897

(22) Filed: Mar. 12, 2019

Related U.S. Application Data
(63) Continuation of application No. 14/370,783, filed on Jul. 7, 2014.
(60) Provisional application No. 61/586,758, filed on Jan. 14, 2012.

(51) Int. Cl. G07B 15/02

(52) U.S. Cl. CPC G07B 15/02

(57) ABSTRACT

Methods for automatic parking of cars in a controlled parking occupancy-status area with unmarked parking spaces, and automatic cellular parking systems (ACPS) enabling such methods. The methods are performed without use of a dedicated in-car device and comprise monitoring of vehicles and parking space occupancy by parking sensors, association of a particular identified parking car with a precise unmarked parking space address and automatic start and termination of a parking session. In some embodiments, the identity of the parking car and associated parking space address are provided by the parking sensors without driver involvement. In some embodiments, the identity of the parking car is provided by the drives using cellular communications.

### CROSS REFERENCE TO RELATED APPLICATIONS

This application is a continuation application from U.S. patent application Ser. No. 14/370,783 filed Jul. 7, 2014 which was a 371 application from international patent application PCT/IB2013/050284 filed Jan. 11, 2013, and is related to and claims priority from U.S. Provisional Patent Application No. 61/586,758 titled “Automated Cellular Parking System” and filed Jan. 14, 2012, which is incorporated herein by reference in its entirety.

### FIELD

Embodiments disclosed herein relate in general to parking methods and systems integrated with parking space occupancy control and more particularly to methods for automated cellular parking in unmarked parking spaces and automated cellular parking systems (ACPS) enabling such methods,

### BACKGROUND

Cellular Parking Systems (CPS) are known and have recently become one of the most popular solutions for collecting on-street parking fees and for controlling the parking process. In a traditional CPS, a driver (or “user”) must register in advance with a CPS operator or “host” and provide details such as driver ID, car license plate number (LPN) or “car ID”, cell-phone number, bank/credit details, etc. Before parking, the driver of a “parking” car (i.e. a car involved in a parking process) must contact the host (e.g. via voice, AVR or SMS) to confirm his/her car's ID, provide its location and launch a parking session. The host opens a parking billing account clock which counts time (and money) as long as the current parking session is on. The billing account clock is closed either by termination of the parking session by an additional call from the driver, or by the expiration of the legal parking time, whichever comes first. At the end of each month, the driver's bank/credit card account is charged by the host. Known CPS are not automatic, do not provide detailed occupancy status information (for example on particular available parking spaces) and require active actions on the part of the driver.

Automated Parking Systems (“APS”) for on- and off-street parking are also known, see e.g. patent application PCT/IL2010/000685 by Ganot, which is incorporated herein by reference in its entirety. PCT/IL2010/000685 lists and discusses advantages and disadvantages of parking systems known prior to that application. In the APS described in PCT/IL2010/000685, the driver must use for payment a dedicated in-car device. The term “dedicated in-car device” refers to a device such as a RF transceiver, and does not include a cell-phone. Alternatively, with some limitations, the APS in PCT/IL2010/000685 also integrates a CPS and accepts cellular payment means. The APS described in PCT/IL2010/000685 cannot operate with unmarked parking spaces (“unmarked” being defined below). It also requires installation of many individual independent control units (“curb devices”) for sensing and for communicating with a car, and requires a dedicated communication network.

U.S. Pat. No. 7,893,847 describes various uses of video cameras for parking spaces sensing. The methods disclosed are limited to marked parking spaces and cannot be applied to unmarked parking spaces. The marked spaces must also be painted with large symbols or special colors in order to enable a camera to determine whether a parking space has become occupied once the symbol or marking is obstructed.

Automatic calibration of a video camera is taught in US patent application 2010/0066828. A calibration object detector detects for example moving objects in a multiplicity of positions (like cars moving along a street) or in a multiplicity of other moving objects in the camera's field of view.

None of the known parking methods and systems can be used for fully automated parking in unmarked parking spaces. None of these methods and systems provides occupancy control. It would therefore be advantageous to have automated cellular parking methods and systems which enable full parking space occupancy control and automatic operation with unmarked parking spaces.

### SUMMARY

Embodiments disclosed herein provide methods and systems for automatic cellular based parking in controlled and unmarked parking spaces. As used herein, “controlled” parking spaces are spaces designated and dedicated to parking under given rules and for which an occupancy status is controlled in real time. As used herein, the term “unmarked parking space” refers to a parking space that has no visual marking which can tell it apart from other parking spaces in a parking area. That is, an “unmarked” parking space is not identified by any unique marking, symbol, number, etc. A system providing automatic parking in controlled unmarked parking spaces is referred to as “Automated Cellular Parking System” or ACPS. An ACPS disclosed herein may use embedded underground sensors or video cameras for parking sensors.

In some embodiments there is provided a method for automatic parking of a vehicle in a parking area with controlled unmarked parking spaces, comprising the steps of: by a host and without use of a dedicated in-vehicle device: receiving a notification that a particular vehicle enters a particular unmarked parking space; receiving a precise address of the particular unmarked parking space; receiving identification information identifying the particular vehicle; associating the identification information with the precise address and automatically starting a parking session; and automatically terminating the parking session upon departure of the particular vehicle from the particular unmarked parking space.

In some embodiments there is provided a system for automatic parking of a vehicle in a parking area with controlled unmarked parking spaces, comprising: a host; a parking sensor which communicates with the host and is operative to monitor a parking vehicle and to identify a particular unmarked parking space and related occupancy; and means to provide a precise address of the unmarked parking space and a parking vehicle ID to the host, wherein the host is operative to associate the precise address with the parking vehicle ID and to automatically initiate and terminate a parking session.

In an embodiment of the system, the parking sensor includes a video camera.

In an embodiment of the system with a video camera as parking sensor, the video camera is capable of reading a car LPN and of license plate recognition (LPR).

In an embodiment of the system, the parking sensor includes an embedded sensor.

In an embodiment of the system with an embedded sensor as parking sensor, the embedded sensor is a buried sensor.

In an embodiment of the system with an embedded sensor as parking sensor, the communication to the host is indirect communication using embedded and user Bluetooth devices.

### BRIEF DESCRIPTION OF THE DRAWINGS

Aspects, embodiments and features disclosed herein will become apparent from the following detailed description when considered in conjunction with the accompanying drawings, in which:

FIG. 1 shows a flowchart of a method for automated cellular parking disclosed herein;

FIG. 2 shows schematically an ACPS operative to implement the method of FIG. 1.

FIG. 3 shows schematically an embodiment of an automated cellular parking system (ACPS) capable of implementing the method in FIG. 1 using buried sensors;

FIG. 4 shows an arrangement of a buried cable and service boxes along a sidewalk with parking spaces in the ACPS of FIG. 3;

FIG. 5 shows horizontal and vertical cross sections of a buried cable in the ACPS of FIG. 3;

FIG. 6 shows schematically a typical block controller positioned in every service box in the ACPS of FIG. 3;

FIG. 7 shows a schematic description of a method for specifying and identifying each segment along the parking area of an ACPS capable of implementing the method in FIG. 1 using video cameras;

FIG. 8 shows a schematic description of a method for capturing the image of a car entering into a parking space including its location of an ACPS capable of implementing the method in FIG. 1 using video cameras;

FIG. 9 shows a block diagram of the camera unit used in an ACPS;

FIG. 10 shows a flowchart of a detailed on-street parking procedure using an ACPS disclosed herein.

### DETAILED DESCRIPTION

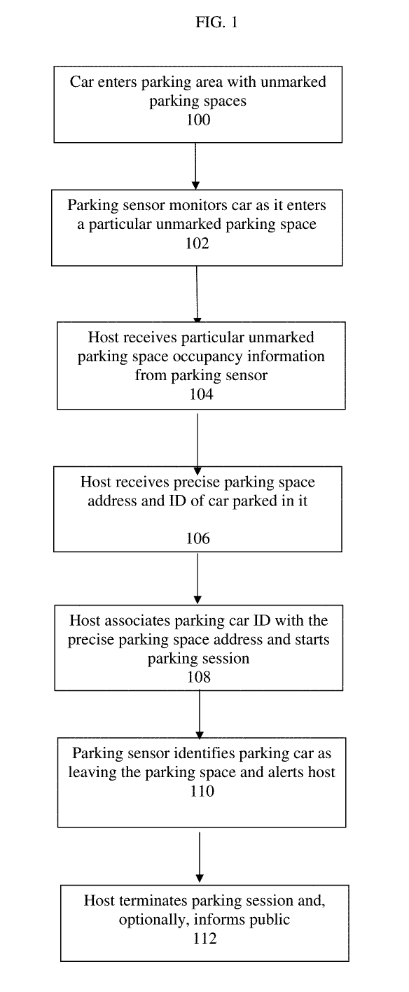

FIG. 1 shows a flowchart of a method for automated cellular parking disclosed herein. The method is implemented in a parking area observed and controlled by an ACPS disclosed below, using the ACPS capabilities. The parking area includes controlled yet unmarked parking spaces which may be parallel to, vertical to, or at an angle with a curb or walkway. Alternatively, the parking area may be an open air parking lot with unmarked parking spaces. In step 100, a particular car enters the parking area. In step 102, at least one ACPS (“parking”) sensor detects the particular car before or as it enters a particular available (empty) parking space. In step 104, a host receives occupancy status for the particular parking space (now “occupied”) as well as for other parking spaces from the parking sensor(s). A “host” is a back-end system which includes billing, customer service, parking space occupancy control and information, and enforcement facilities and capabilities. In step 106, the host receives identifying parking space and particular car information. This information includes a precise parking space address and a driver ID or car license plate number of the particular car. In an ACPS with embedded sensors or regular (not LPN- or LPR-enabled) video cameras serving as parking sensors, the information is received respectively from a driver cell-phone Bluetooth unit or from the cell-phone. In an ACPS with LPN- or LPR-enabled cameras serving as parking sensors, the information is received from a camera. In all embodiments and advantageously, the information is relayed to and received by the host without involvement of any dedicated in-car device, unlike in the method disclosed by PCT/IL2010/000685. The host has access to a database which stores previously registered information on the particular car and its driver. In step 108, the host associates the particular car with the precise parking space address and launches automatically a parking session. In step 110, the parking sensor identifies the particular car as leaving the particular parking space and reports the particular parking space as available to the host. Consequently, in step, 112, the host terminates the parking session automatically, without involvement by the driver.

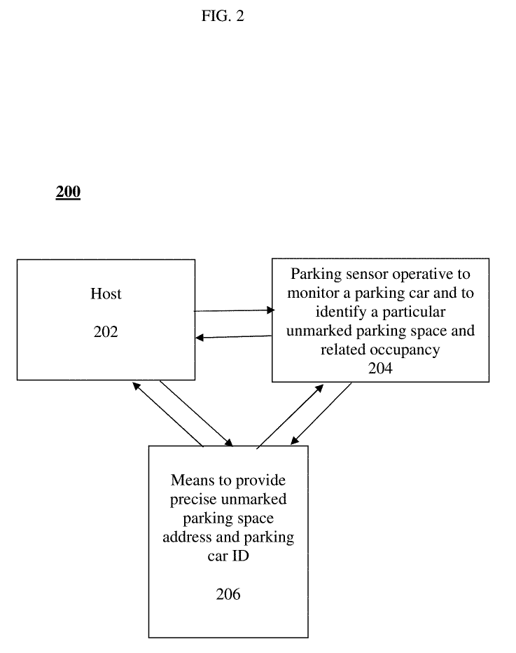

FIG. 2 shows an embodiment of a general ACPS capable of implementing the method described in FIG. 1, numbered 200. ACPS 200 comprises a host 202, at least one parking sensor 204 operative to monitor a parking car during a parking session as well as to provide parking space occupancy status (identify a particular parking space as occupied or unoccupied), and means 206 to provide a precise parking space address of the parking car as well as the car's ID. Host 202 is capable of communicating directly (e.g. through cellular communications) or indirectly (through an intermediary) with each parking sensor and parking car or its driver. Host 202 is further capable of storing registration information regarding car and drivers, and using such stored information before, during and after a parking session. Following are detailed descriptions of two implementations of such an ACPS.

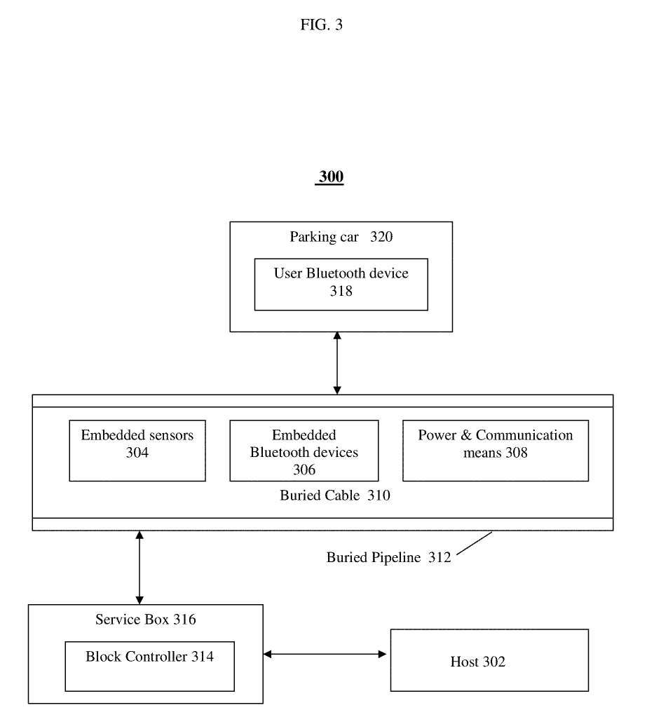

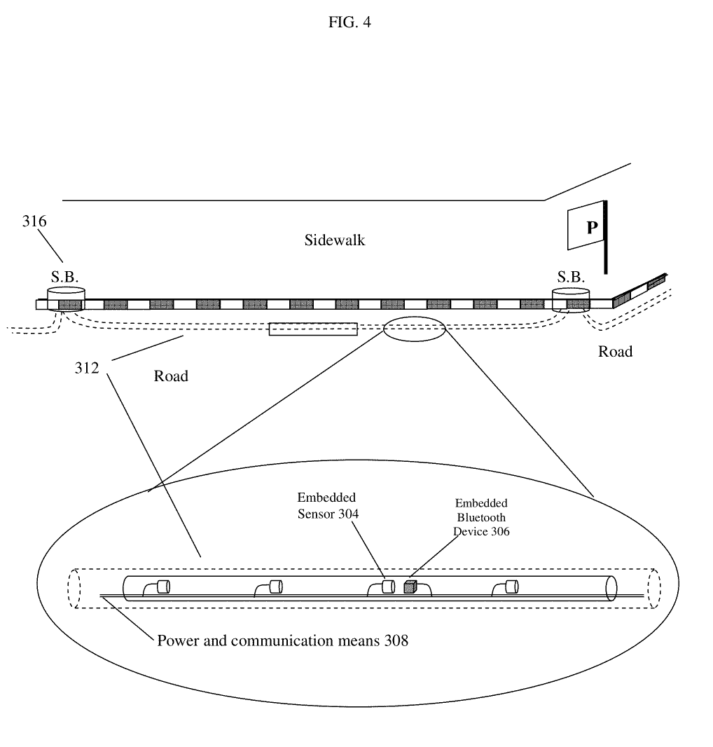

FIG. 3 shows a first implementation of an ACPS disclosed in FIG. 2, numbered 300. ACPS 300 comprises a host 302 in communication with a plurality of parking sensors 304. In an embodiment, host 302 may be similar to a host described in detail in PCT/IL2010/000685. Sensors 304 are embedded together with Bluetooth devices 306 and power and communication means 308 in a buried cable 310. The embedded sensors and Bluetooth devices communicate with the host through means 308 and through a block controller 314 placed in a service box 316. Means 308 are wired to the block controller, which also powers sensors 304 and embedded Bluetooth devices 306. Cable 310 may be buried directly in the ground or may be placed inside a protective buried pipeline 312. As used herein “buried pipeline” and “buried cable” relate therefore to articles positioned under a paved surface along a road, sidewalk or parking curb and extending at least the length of a block, see FIG. 4. In some embodiments, a single block controller controls parking activity in a parking area, through interaction with buried sensors and communication devices in a cable connected thereto, and through further interaction with the host. The parking spaces in the block are thus “controlled” yet “unmarked” per the definition above.

Embedded sensors 304 can sense the presence or absence of a parking car 320 in a particular parking space associated with a precise address. Embedded Bluetooth devices 306 communicate with a “user” Bluetooth device 318 (which may be located in the parking car 320 or carried by the driver, being integrated within the driver's cell-phone). “Bluetooth” is used herein as a particularly enabling example for a short range communication method and protocol which is independent of the cellular communication system in use. However, other communication methods and protocols may be used in some embodiments disclosed herein. The embedded sensors are chosen such that they have very short sensing ranges, on the order of 1-2 meters. The effective communication range of an embedded Bluetooth device is also relatively short, typically on the order of up to 10 meters. The user Bluetooth device is coupled to the ACPS Bluetooth network (which includes all embedded Bluetooth devices) during a registration procedure described below. This is done in a known way, and, advantageously, enables hands-off operation and communication once the user and embedded Bluetooth devices reach a communication distance. Each embedded Bluetooth device 306 is given its own unique ID number and is linked to the nearest street address in a way which enables the identification of the street address via the unique ID. Similarly, each embedded sensor 304 is given its own unique ID number. During various parking scenarios described in more detail below, embedded Bluetooth devices and user Bluetooth devices communicate directly with each other.

In an embodiment, pipeline 312 may be a protective, water-tight, flexible hollow tubular structure adapted for burial under a paved road surface. Pipeline 312 may be exemplarily made of a plastic or rubber material and may typically have a diameter of approximately 1-2″. The material may be chosen to provide minimal impact on embedded sensing and Bluetooth communication ranges. In an embodiment, cable 310 may be a cast cable with an embedded chain of wired electronic components (i.e. the sensors and transceivers) similar to (for example) LED decorating lighting cables. The cable may be pulled through pipeline 312 from the service box. If needed (e.g. for maintenance purposes), an existing cable can be easily replaced by a new cable. In an embodiment, sensors 304 are magnetic sensors which are spaced appropriately along the cable. Exemplarily, sensors 304 may be spaced 0.5-1 meter apart. Other spacing may be of course possible. In other embodiments, other types of embedded sensors which sense the presence or absence of a parked car in a particular parking space may serve purposes set forth herein. Similarly, embedded Bluetooth devices 306 may be spaced apart such that each Bluetooth device is associated with a particular street address or position. The cast cable components may be positioned at short distances from one another in order to cover the parking area independently of the distances between the parking vehicles along the unmarked parking spaces.

In an embodiment in which a pipeline cannot be buried under the surface of the street or the sidewalk, the pipeline may be hanged above the parking spaces.

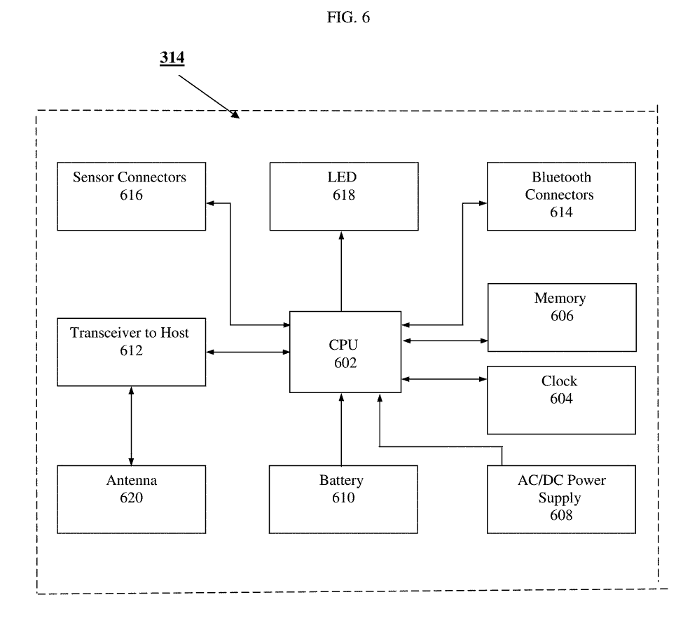

The embedded sensors and Bluetooth devices are electrically coupled to a Bluetooth link of the block controller, details of which are shown in FIG. 6. Each block controller may be programmed by the host with the relevant parking regulations for each parking space. The programming may be done on-line or off-line. The regulations may exemplarily include parking rates for different times and/or users and parking time limits per day and/or per hour. The information may be updated in real time by the host. Box 316 may be similar to known street underground infrastructure service boxes (“S.B.”), and may be buried under the paved surface at a chosen location (e.g. proximal or distal end) of each parking block as shown in FIG. 4. Block controller 314 powers and manages the operation of the sensors and the communication between (cable) embedded and user Bluetooth devices. Block controller 314 may be powered by an AC street lighting system (or alike) and may perform AC/DC conversion to provide DC power to various components. Block controller 314 may communicate by wired means or remotely with host 302 via a communication unit 612 in FIG. 6, using for example cellular, WiFi or RF communications.

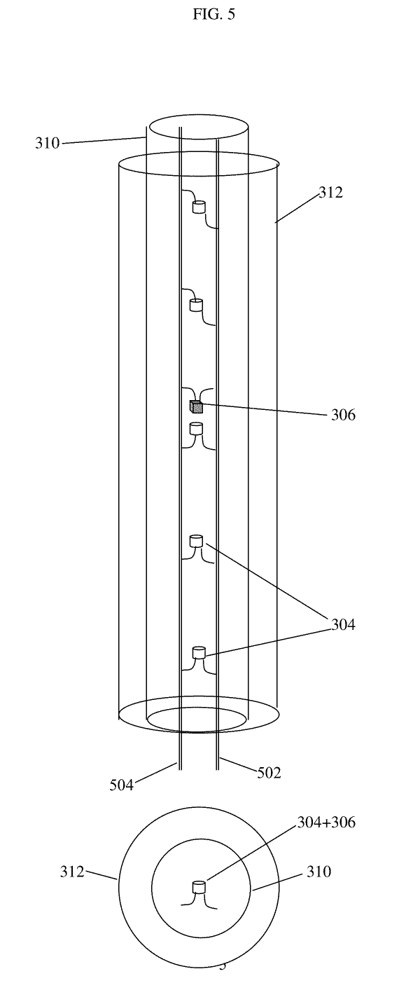

FIG. 5 shows radial and longitudinal cross sections of pipeline 312 and cable 310 which illustrate the placement of the embedded sensors and Bluetooth devices and their wiring to the block controller. Each embedded sensor or Bluetooth device is operationally coupled to an electric power supply line 502 and to a communication line 504. Each sensor or a Bluetooth device includes a small non-volatile memory unit (not shown) which stores its respective unique ID. The ID may be programmed into the memory prior to the embedding of the Bluetooth and of the sensor units into cable 310. After inserting the cast cable and connecting its wires to the block controller, the initial programming of the block controller includes the marking of each component, (embedded sensor and Bluetooth device, through its ID) along the cable by the relevant street address. The association of the ID with address can be done easily, as the distance of each component from the service box, as well as the distance of each identified parking point from the service box, are known. Thus, every single component which is identified by its unique serial number along the cast cable represents a certain street address according to its geographical location.

FIG. 6 is a diagram of a typical block controller 314 positioned in every service box. Each block controller includes: a microprocessor or CPU 602 for controlling and managing the block's parking operation; a clock unit 604 for regulating the communication between CPU 602, embedded sensors 304, Bluetooth devices 306 and host 302; a memory unit 606 for storing embedded sensor and Bluetooth device IDs, respective parking addresses, relevant parking regulations, a block controller operating program, etc.; an AC/DC power supply unit 608 which, preferably, can accept AC power from the street infrastructure (lighting, etc.) and convert it to the DC power; an optional backup battery 610; a communication unit 612 for communicating with the host; a connection line 614 to the cable embedded Bluetooth devices; a connection line 616 to the cable embedded sensors; optionally a LED 618 for indicating the functionality of the CPU; and an antenna 620 for wireless communications with the host.

The block controller may communicate periodically according to a certain routine with all the cable components and the embedded sensors and Bluetooth devices of the local block. This may be done for instance by dedicating a connection period of 5-10 msec to each of the components, such that the block controller communicates with, and controls all the components approximately once a second. According to this routine, these cable components are powered only while in communication with the block controller. Thus, they need not be powered most of the time, saving energy while providing on-line control of the parking spaces.

Embedded sensors may be powered in unmarked yet controlled parking spaces only during charging hours (for example during the day between 8 am and 8 pm). As for the embedded Bluetooth devices, they may be activated by the block controller only when the neighborhood sensors indicate an approaching car. The embedded Bluetooth devices can then be powered off once the parking handshake with a parking car is completed.

### Registration Procedure

During this procedure, the Bluetooth channel of driver's cell-phone is coupled to the Bluetooth channel of the operator. With a camera-based ACPS system (see below), the driver needs not couple his Bluetooth to another Bluetooth device, but may be required to download a dedicated software application to his cell phone.

### Handshake Procedure in Embedded Sensor ACPS

After registration, whenever a car approaches a parking area, the nearest parking sensors follow its maneuvering until it comes to a stop in a particular parking space. The CPU in the block controller analyzes the strength and the intensity of electronic signals collected from the embedded sensors and selects an embedded Bluetooth device nearest to the parked car. The block controller then activates the selected Bluetooth device to launch communication with the user's Bluetooth device to perform a handshake procedure needed to initiate the current parking session. During the handshake procedure, the user Bluetooth device may transmit only its registered given ID number or its cell-phone number. These automatically represent to the host all necessary driver and car details, such as driver's name, cell-phone number, car's license plate number, etc. The embedded Bluetooth device transmits to the driver's cell-phone information such as parking time limits, parking location address and rates. The block controller informs the host on the occupancy and the enforcement status of the particular parking space.

### Parking and Termination Procedure in Embedded Sensor ACPS

After completing the handshake procedure, the block controller turns off the power to the selected embedded Bluetooth device but keeps powering the embedded sensors, according to the routine described above. When the car leaves the parking space, the embedded sensors around the departing car sense the departing and update the block controller, which in return terminates the current parking session and updates the occupancy and the enforcement status accordingly. The following example provides more details and scenarios.

### Example for Parking Procedure Using Embedded Parking Sensors

When a driver approaches his/her final parking location, several of the embedded sensors (characterized by a very short range sensing distance) sense and trace the car while it maneuvers to its final parking space. After the car stops moving, the block controller analyzes the sensors information, determines the precise car parking location and activates the nearest Bluetooth device for communicating with the parking car. The communication (“handshake”) is explained with reference to Table 1 which shows a number of parking events involving four cars 320A, 320B, 320C and 320D and the actions taken by various embedded sensors and Bluetooth devices.

The first column in Table 1 represents parking location address identified by IDs P200 to P202 (total of 3 parking spaces). In this example, the width of a parking space (illustrated by the number of cells related to PXXX, each cell representing a length of 1 meter) is 5 meter. In order to ease the understanding we use in this example fixed size spaces of 5 meters each. However it should be noted that as this application is based on unmarked parking spaces the width of a space may be changed in practice according to the size of the parking car and its final location will be reported by the sensors according to its street address. The second column represents the embedded sensors along the cable, identified by IDs S100 to S114 (total of 15 sensors). The sensors are spaced 1 meter apart (thus one sensor per cell in the column). The third column represents the embedded Bluetooth devices along the cable identified by B300 to B302 (total of 3 units) and spaced 5 meter apart. Symbol “+” represents the status of a sensor which is “On” but which does not sense any car. Symbols “++” represents the status of a sensor which is “On” and which senses a car in its range (proximity).

TABLE 1

| Parking | | | | | | | | | |
|---|---|---|---|---|---|---|---|---|---|
| location | | | | | | | | | |
| address | Sensor | Bluetooth | Car | Car | Car | Car | Car | Car | Car |
| ID | ID | ID | ID | ID | ID | ID | ID | ID | ID |
| P200 | S100 | B300 | + | + | + | + | + | + | + |
| | S101 | | ++ | ++ | ++ | ++ | + | + | + |
| | S102 | | ++ | ++ | ++ | ++ | + | + | + |
| | S103 | | 320A | 320A | 320A | 320A | + | + | + |
| | S104 | | ++ | ++ | ++ | ++ | + | + | + |
| P201 | S105 | B301 | ++ | ++ | 320C | ++ | + | + | + |
| | S106 | | + | + | ++ | + | + | + | + |
| | S107 | | + | + | ++ | + | + | + | ++ |
| | S108 | | + | + | + | + | + | + | ++ |
| | S109 | | + | + | + | + | + | + | 320D |
| P202 | S110 | B302 | + | ++ | ++ | ++ | ++ | + | ++ |
| | S111 | | + | ++ | ++ | ++ | ++ | + | ++ |
| | S112 | | + | 320B | 320B | 320B | 320B | + | + |
| | S113 | | + | ++ | ++ | ++ | ++ | + | + |
| | S114 | | + | ++ | ++ | ++ | ++ | + | + |
| Parking | | | 320A | 320B | 320C | 320C | 320A | 320B | 320D |
| Event | | | parks | parks | parks | departs | departs | departs | parks |

Assume that a first car 320A enters space P200. All sensors are “On”. Assume 320A maneuvers close to sensor S103, i.e. closer to a second end (4^{th} cell down the column) of the 5 meter parking space. S103 indicates to the block controller that a car approaches the parking space in its vicinity. Quite likely, sensors S102 and S104 will provide a similar indication while sensors S101 and S105 may or may not do the same. CPU 602 (in FIG. 6) analyzes these indications and decides that the car parks next to sensor S103. CPU 602 then selects Bluetooth device B300 as the nearest to car 320A and activates it to communicate in order to reach a handshake with car 320A. Next, assume that a second car 320B enters space P202 and parks in its middle (3^{rd} cell down the column) of a 5 meter parking space. Sensor S112 indicates this occupancy, while sensors S111 and S113 probably indicate the same with high certainty. Sensors S110, S114 may indicate the same, but with lesser certainty. In this case, CPU 602 selects Bluetooth device B302 to communicate with car 320B. Next, assume a third car 320C enters space P201 and decides to park at a first end (top cell in the column) of the space. Sensor S105 and probably sensors S106 and S107 indicate the approaching of the car. However, sensors S104 and S105 are still busy sensing car 320A and therefore cannot be counted by CPU 602 for this analysis. Therefore, CPU 602 is missing information. Moreover, the distance of car 320C to Bluetooth device B300 is about the same as the distance to Bluetooth device B301. However, as Bluetooth device B300 was turned off after the handshake with 320A, the nearest one left is Bluetooth device B301 and this will be the one selected for communicating with car 320C. Finally, assume a car 320D enters the parking area, and as the street is empty, it parks at the end of P201. Sensors S107 to S11 now send occupancy signals. CPU 602 selects the middle sensor S109 and, accordingly, activates Bluetooth device B301.

After selecting the correct Bluetooth device nearest to a parking car, the block controller launches via this device a communication dialogue with the user Bluetooth device. The parties then automatically exchange ID information. While the driver's phone receives its precise location including address, parking time limit and parking rate, the embedded Bluetooth device receives the car's ID, which is forwarded to the block controller. At this stage, there are two options: in a manual option, the driver must confirm the start of the parking session by pressing a dedicated key of his/her phone, otherwise the parking session is not acknowledged. In an automatic option, (if this option was selected at the registration stage by the driver) the parking session starts automatically without confirmation. Next, the block controller sends the car ID to the host and updates the host regarding the occupancy of the particular parking space. The host activates the driver's account, starts counting the parking time and charges accordingly until the driver terminates the current parking session or the parking time limit expires, whichever comes first.

In some instances, the driver's phone must follow a pairing or coupling procedure with the system's embedded Bluetooth network for acquaintance and ease of communication. This can be done during the registration procedure. At this stage, certain communication templates can also be programmed in the driver's cell-phone. All these registration procedures can also be provided to the driver remotely as a download from an operator's website.

If the car is registered and if the car parks in a legal place (“legal” depending on the status of the driver/car, such as residence, handicapped, etc.) the parking session is confirmed. After confirmation (whether automatically or manually), the driver's account starts charging and the information regarding the occupancy of the parking space is updated and can be provided to the public by a variety of means, such as street electronic signs, GPS, etc.

In case the car is not identified or in case the parking is not confirmed (for instance when a confirmation of the driver is required), or in case the car parks illegally (in terms of space and time), the occupation information received from the nearest sensors is still updated by the block controller, but an enforcement unit is informed and an inspector is sent to the particular parking space. Alternatively, a warning is issued to the driver prior to the deployment of the inspector.

When a parked car leaves the parking space, the nearest sensor senses the departure and alerts the host. In return, the host stops charging, closes the billing session and updates the parking occupation information in real time. Since the billing session is stopped automatically when the car leaves the parking space, the driver is charged only for the time actually spent parking.

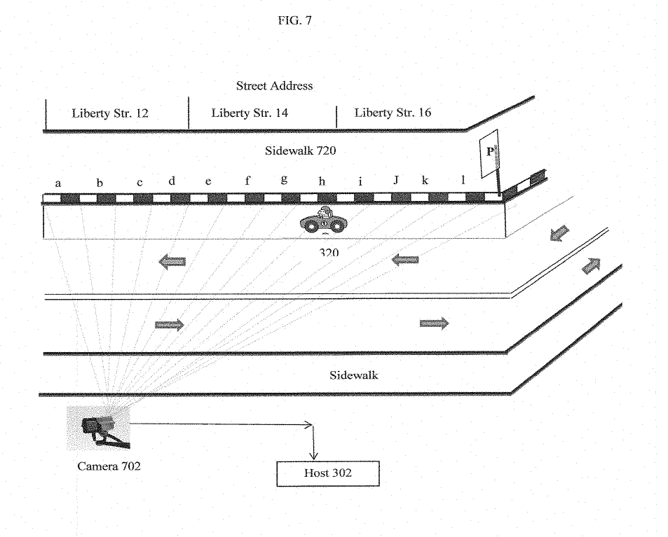

FIG. 7 shows a second implementation of an ACPS disclosed in FIG. 2, which uses a video camera 702 as a block parking sensor. As used herein, “camera” or “video camera” is a unit which may include one or more cameras configured to detect, view, follow, identify and calibrate moving objects within a field of view. A camera unit has ability to calibrate a particular moving object in a multiplicity of positions and among a multiplicity of objects, and to distinguish between such objects. The camera unit may be adapted to perform 2D-to-3D conversion and processing, as known in the art. It may include other means for sensing the position and the movement of a detected item (e.g. a laser, a radar, etc.). A camera unit may also be capable of processing images and communicate with a host 302 via wired or wireless communication means. In some embodiments of a “camera-based ACPS”, the camera may be LPN-enabled or LPR-enabled. Such a camera can be used to identify the particular parking car and to report to the host both the car ID and the precise parking space address, the latter obtained as described next.

Returning to FIG. 7, camera 702 views a parking area the length of a block along a sidewalk 720. The parking spaces are unmarked. The camera is capable of providing parking space occupancy information by identifying a particular space at a particular address as full or empty (see details below). The camera may programmed with software which divides the block into small segments of exemplarily 0.5-1.0 meter, marked in FIG. 7 as “a”, “b”, “c”, “d”, etc. A group of several such segments represents a single parking space. Each segment is defined by a function which uses various parameters such as distance to the camera, angle to the camera, or both. In addition, each segment is referred to a street address to which it belongs. Exemplarily and as shown, segments a-d refer to address “Liberty 12” while segments e-h refers to address “Liberty 14”.

In use, assume a particular car 320 enters the parking area represented by the block. The car is detected as it enters a particular unmarked parking space (e.g. a space located between segments h-j). The camera determines that the car parks in segment “h” i.e. in a particular unmarked parking space having 14 Liberty Street as address, and provides this information to the host. The host thus receives the precise address of the parking space from the camera. Through a handshake procedure launched by the driver via his/her cell-phone, or, in case of a LPR-enabled camera, through reception of the car ID information from the camera, the host associates the particular car with “14 Liberty Street” and starts automatically a parking session for that car. A non-LPN- or LPR-enabled camera may also receive the identity of the particular car from a dedicated LPN (or LPR)-enabled camera which is positioned such that it reads the LPN of the cars moving into a controlled block. Through the parking session, the camera monitors the car and the parking space. When the car leaves the parking space, the camera alerts the host. The host then terminates the parking session automatically.

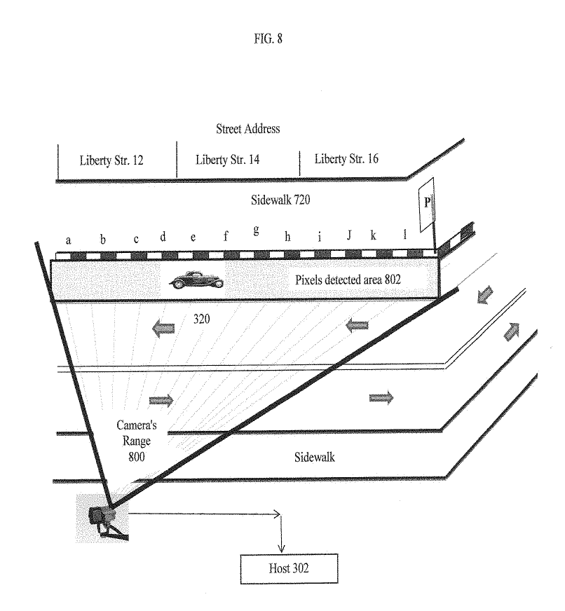

FIG. 8 provides an example of how the camera senses occupancy status (i.e. whether a parking space is empty or occupied). Once the camera is positioned into a fixed location, the camera is programmed to distinguish between pixels of a total viewed range 800 and pixels relating only to parking dedicated spaces 802 (a, b, c, . . . l). The camera is further programmed to recognize background colors and objects along the parking block. Once a car occupies the space before Liberty 14, the pixels at segments d-f exhibit a disturbance (change) relative to the programmed background and known objects. The camera determines from this disturbance that a car has parked in the parking space within Liberty 14 as address and reports this event to the host. Alternatively, the camera can be programmed with a variety of shapes of different typical vehicles. The camera may then recognize the shape of a car when it enters one the unmarked parking spaces, and report this particular (now occupied) space to the host.

A camera can update the host regarding the occupancy status of the entire block. Assume that the length of the block is 60 meters, and that a typical car occupies a parking space 4 meters in length. The camera may measure the total length of the parked cars. Assume that five cars are now parked in the block. Their total length is 20 meters. Thus 40 meters of the total 60 (66%) are still free, and the camera reports to the host that 11 spaces (60/4-5) are still available. Alternatively, the camera can measure distances between the parked cars and determine how many spaces are still available.

In some embodiments, the driver has the option to confirm the parking session by another massage. In case the car does not stop for parking, the camera ignores the car and stops tracing it.

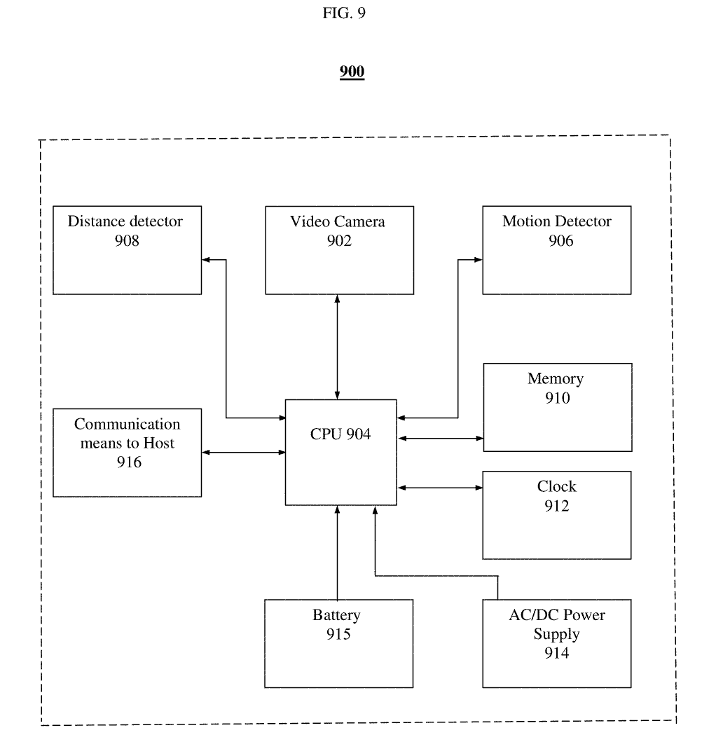

FIG. 9 provides a schematic block diagram of a camera unit 900. The unit is controlled by a CPU 904. It includes a motion detector 906 for monitoring cars, and distance and/or angle detectors 908 for identification of a final parking place from a parking car's position toward the camera. The camera unit may include other elements, similar to those in an embedded sensor unit, for example a memory 910, a clock 912, a power supply 914 and/or battery 915 and communication means 916 for communicating with the host.

Handshake Procedure and Termination with the Camera-Based ACPS

After registration, whenever a car approaches a parking area, the camera follows its maneuvering until it comes to a stop in a particular parking space. The camera determines the precise location of the parking car and updates the host regarding the change of the occupancy status of this particular space/address. If the camera is non-LPR-enabled, the driver launches an “active handshake” by activating his/her GPS device and transmitting to the host the car location and the car or the driver ID. The host compares the location information received from both the camera and the GPS, and if they match, checks whether this car is registered and allowed to park at this particular space and time (residential or handicapped limitations). If yes, a confirmation massage is sent by the host to the driver's cell-phone and the handshake is completed.

If the camera is LPR-enabled, the camera sends to the host the parking car location together with its ID. The host performs the checks above and allows parking without the need for the driver to actively launch a handshake as above.

After completing the handshake procedure, the camera continues its monitoring and, as soon the car leaves the area, the camera updates the host, which in turn stops the parking session charge and updates parking occupancy information.

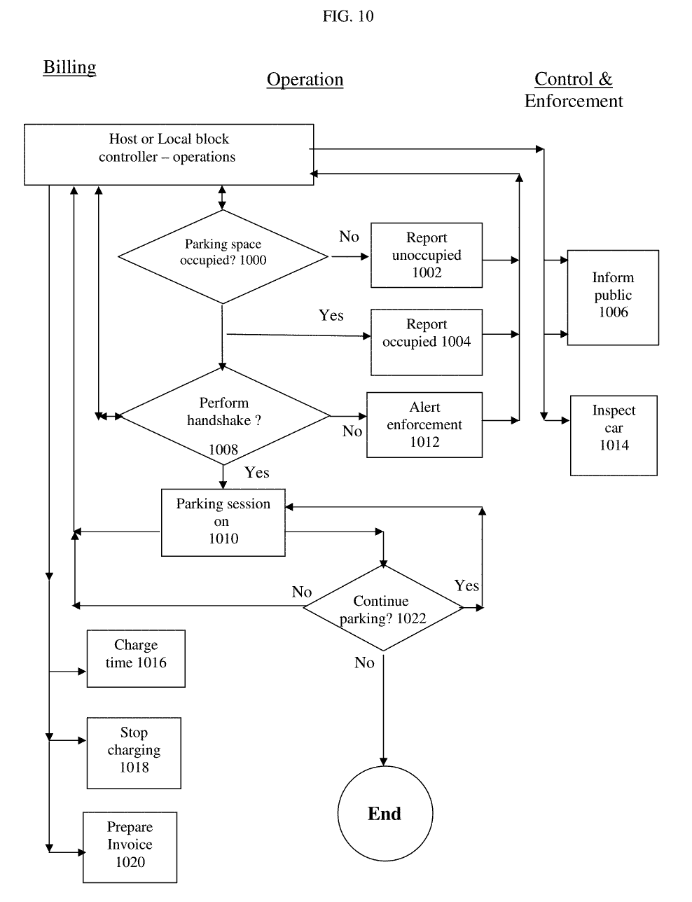

FIG. 10 shows a flowchart of a detailed on-street parking procedure using an ACPS disclosed herein. The flowchart illustrates the electronic “dialogue” between parking cars and host from the point of view of the host, with one or more local cameras or a block controller serving as “eyes” to the host. In step 1000, a parking sensor determines whether a particular parking space is busy (occupied) or not. If the parking space is unoccupied (No), its status is reported in step 1002 to the host, directly (in the camera-based system) or indirectly (through a block controller in the embedded sensor system). The host then passes this information on to the public in step 1006. This can be done by various means, for example by using electronic boards or signs, or a dedicated navigation application of the user's cell-phone. If the parking space is occupied, its status is reported to the host in step 1004 and a check on whether a handshake is performed is done in step 1008. The host then informs the public as above. In an embedded sensor based ACPS, the block controller selects the nearest embedded sensor and communication device to represent the parked car.

A handshake is not performed in a few cases: if the car ID does not match the registration details and/or the current parking regulation; if the parking car does not respond to the embedded communication device calls, or; if the location reported by the driver with the camera-based system doesn't match the location reported by the camera. In this case, the host alerts the parking enforcement in step 1012, and an inspector is sent to check the car in step 1014 to take appropriate action.

If the handshake is performed, (Yes), the host communicates a confirmation to the driver (directly or indirectly) in step 1010. The confirmation may be transmitted together with other useful information such as parking time limit, parking fee, car parked address, etc. After that, the host activates a parking time counter in step 1022, and a billing account for the parked car (“customer”) in step 1016. The billing continues as long as a legal parking session is on, step 1022. The billing stops in step 1018 if either of two conditions are met: a) if the sensors (step 1000) report that the car has left the particular parking space (i.e. report that the particular parking space is “unoccupied”), or b) is a maximal parking time limit has been reached (step 1022), whichever comes first. At the end of the parking session, the host prepares an invoice in step 1020. The invoice is then sent to the driver.

In case the parked car exceeds the maximal parking time limit in step 1022, which is controlled directly by the host (in the camera-based system) or by the block controller (in the embedded sensors system), the parking session is terminated in step 1010, the billing stops as above, and, in the embedded sensor system, the block controller alerts (via the host) the enforcement as above. In the camera-based system, the enforcement is alerted directly by the host.

Integrating an ACPS with Automated Parking Garages

The ACPS disclosed herein may be applied in fully automated, barrier controlled parking garages. Each one of the garage parking spaces may be equipped with embedded ACPS embedded sensors or with the ACPS video cameras. The gate will be equipped with similar sensing means and with communication means either cell-phone transmitter or Bluetooth transmitter (for the Camera-based ACPS or for the embedded sensor ACPS respectively). This equipment will be able to open the gate once the registered driver approaches the gate. The parking garage controller will be similar to the block controller of the ACPS, will include a remote communication unit for communicating with the database of the host and means for controlling on-line the occupancy status of the garage parking spaces, which means are known and are in use in many garages.

In this operation, when a car approaches the garage gate, the ACPS sensor updates the controller and the latter checks if parking spaces are available. If yes, the gate communicates with the user's cell-phone device or with its Bluetooth device (for the camera ACPS or for the embedded sensor ACPS respectively) and runs the same handshake protocol as described for the ACPS above. In case the car is registered and recognized, the gate opens and the driver's account is charged from the entering time.

When the car approaches again the gate for leaving the garage, the gate sensor activates the same communication unit, which in return captures the ID of the departing car by communicating with the driver's cell-phone or with his Bluetooth (with the camera ACPS or the embedded sensors ACPS respectively). The gate opens again and the operator stops charging the driver's account.

In conclusion, with an ACPS disclosed herein, on-street parking procedures in unmarked parking spaces become fully automated. The start of a parking session is a hands-off, automated operation. So is the termination of a parking session. Unlike in a traditional CPS, once the driver has removed his/her car from the parking space, his/her parking account is closed automatically. Such an ACPS can provide significant savings in enforcement costs, as enforcement is needed only for parking violators, who can be identified and located automatically by the ACPS.

While this disclosure describes a limited number of embodiments, it will be appreciated that many variations, modifications and other applications of such embodiments may be made. The disclosure is to be understood as not limited by the specific embodiments described herein, but only by the scope of the appended claims.

What is claimed is:

1. A method for automatic parking of a vehicle in a parking area with controlled unmarked parking spaces, the method comprising the steps of:
by an automated cellular parking system (ACPS) comprising a host, a plurality of parking sensors, Bluetooth devices or devices using other communication method and protocols, power and communication means for communication with host and a block controller:
a) detecting, by the parking sensors, if a vehicle enters a particular unmarked parking space, wherein the parking sensors are embedded in a buried cable or hanged above the parking space, together with the Bluetooth devices or with the devices using other communication methods and protocols and with the power and communication means, and wherein the parking sensors and the Bluetooth devices or the devices using other communication methods and protocols are given each their own respective unique ID number and are linked to the nearest street address in a way which enables identification of the nearest street address via their respective unique ID number;
b) automatically receiving, at the Bluetooth devices or at the devices using other communication methods and protocols, information identifying the vehicle from a user's wireless communication device
c) receiving, at the host, occupancy information on unmarked parking spaces in the parking area with controlled unmarked parking spaces;
d) associating the information identifying the vehicle with a precise address of the particular unmarked parking space obtained the Bluetooth devices or the devices using other communication methods and protocols;
e) automatically starting a parking session; and
f) automatically terminating the parking session upon departure of the vehicle from the particular unmarked parking space, wherein at last one parking sensor identifies when the vehicle leaves the particular unmarked parking space and reports to the host the particular parking space as being available,
wherein steps (a) to (f) are performed without use of a dedicated in-vehicle device.

2. The method of claim 1, wherein the vehicle has a respective driver and wherein the step of receiving information identifying a vehicle includes receiving an ID of the driver by cellular communication from the driver.

3. The method of claim 1, wherein the step of automatically starting the parking session comprises confirming the parking session, confirming that the vehicle is registered and confirming that the vehicle is not parking illegally, and after confirmation, starting charging an account of the respective driver and updating, at the host, information regarding occupancy of the parking space.

4. The method of claim 2, wherein in case the vehicle is not identified, in case the parking is not confirmed, or in case the particular vehicle parks illegally, the parking space occupancy information is still updated by block controller which receives the parking space occupancy information from parking sensors via power and communication means, and an enforcement unit is informed and an inspector is sent to the particular parking space, or a warning is issued to the respective driver prior to the sending of the inspector.

5. The method of claim 1, wherein when the vehicle leaves the parking space, a nearest parking sensor senses the departure and alerts the host, which, in return, stops charging, closes a billing session and updates the parking occupancy information in real time such that the respective driver is charged only for time actually spent parking.

6. A system for automatic parking of a vehicle in a parking area with controlled unmarked parking spaces, comprising:
a) a host acting as a back-end system;
b) a plurality of parking sensors embedded in a buried cable or hanged above the parking space, the parking sensors) operative to monitor a vehicle and to identify a particular unmarked parking space and related occupancy, the parking sensors communicating directly or indirectly with the host; and
c) a plurality of Bluetooth devices or devices using other communication methods and protocols embedded in a buried cable or hanged above the parking space, each parking sensor, Bluetooth device or device using other communication methods and protocols given its own respective unique ID number and being linked to a nearest street address in a way that enables the identification of the nearest street address via the unique ID number,
wherein the host is operative to associate a precise address of the particular unmarked parking space received from at least one Bluetooth device or at least one device using other communication methods and protocols with a vehicle ID number and is operative to automatically start, charge and terminate a parking session based on information received automatically at the Bluetooth devices or at the devices using other communication methods and protocols from a user's wireless communication device and based on the respective unique ID numbers of the Bluetooth devices or at the devices using other communication methods and protocols.

7. The system of claim 6, wherein the host is further operative to publicly provide parking space occupancy information.

8. The system of claim 6, wherein the buried cable comprising the parking sensors extends at least the length of a parking block.

9. The system of claim 6, further comprising a block controller that powers and manages operation of the parking sensors and the power and communication means.

10. The system of claim 6, further comprising an AC/DC power supply unit that accepts AC power from street infrastructure for conversion of the AC power into DC power, the AC/DC power supply unit being comprised in the block controller.

11. The system of claim 9, wherein the block controller is programmed by the host with relevant parking regulations for each parking space.

12. The system of claim 6, wherein each parking sensor is operationally coupled to an electric power supply and to a communication line.

13. The system of claim 6, wherein the parking sensors are powered in unmarked yet controlled parking spaces only during charging hours.
